(19) United States
(12) Patent Application Publication
(10) Pub. No.: US 2020/0086661 A1
(43) Pub. Date: Mar. 19, 2020

(54) PRINTER

(71) Applicant: Roland DG Corporation, Hamamatsu-shi (JP)

(72) Inventor: Hironobu SUZUKI, Hamamatsu-shi (JP)

(21) Appl. No.: 16/566,986

(22) Filed: Sep. 11, 2019

(30) Foreign Application Priority Data
Sep. 19, 2018 (JP) 2018-174820

(51) Int. Cl. B41J 11/00

(52) U.S. Cl. CPC B41J 11/002

(57) ABSTRACT

A printer includes a support on which a medium is placed, an ink head including nozzles that discharge an ink to the medium on the support, a conveyor that conveys the medium from one side to the other side, a plasma generator including an irradiation port that downwardly radiates plasma and provided over the support so as to be locatable in a position that overlaps the support in plan view, and an insulator provided on an upper surface of the support to be opposed to at least the irradiation port to insulate the support and the medium from each other. When a range of the medium which has been irradiated with the plasma by the plasma generator is an irradiated range, the ink head is disposed in a position in which the ink is discharged to the irradiated range of the medium.

### CROSS REFERENCE TO RELATED APPLICATIONS

This application claims the benefit of priority to Japanese Patent Application No. 2018-174820 filed on Sep. 19, 2018. The entire contents of this application are hereby incorporated herein by reference.

### BACKGROUND OF THE INVENTION

### 1. Field of the Invention

The present invention relates to a printer.

### 2. Description of the Related Art

For example, a printer disclosed in Japanese Patent Publication No. 6284021 includes a platen on which a medium is placed, an ink head that discharges an ink to the medium placed on the platen, and a carriage in which the ink head is provided. The above described printer is configured such that the ink is discharged from the ink head while the ink head moves in a main scanning direction. The printer is also configured such that the medium placed on the platen is moved to a sub scanning direction that is perpendicular to the main scanning direction in plan view.

Also, in the printer disclosed in Japanese Patent Publication No. 6284021, a plasma irradiation mechanism that irradiates the medium placed on the platen with plasma is provided in the carriage. The medium placed on the platen is irradiated with plasma, and thereby, a surface of the medium is modified and an affinity between the medium and the ink can be increased. In the above described printer, the ink is discharged from the ink head to a range of the medium which has been irradiated with the plasma, and thereby, printing is performed.

Incidentally, there is a probability that, in the printer, the medium placed on the platen floats up from the platen due to temperature change or the like. When printing is performed on the floating medium, an ink hitting position is shifted, and therefore, printing unevenness occurs in some cases. As a result, printing quality is reduced in some cases.

### SUMMARY OF THE INVENTION

In view of the foregoing, preferred embodiments of the present invention provide printers that each decrease or prevent a reduction of printing quality.

A first possible factor in printing unevenness due to floating of a medium from a platen is that a distance from the ink head to the medium placed on the platen is reduced to be relatively short. When the distance from the ink head to the medium is reduced to be short due to floating of the medium, shifting of the ink contact position on the medium occurs. As a result, printing unevenness occurs. The present inventor conducted various examinations of whether there is any other factor than the distance between the ink head to the medium that could be a factor in the occurrence of printing unevenness. As a result, the present inventor discovered that electric charges are generated in each of the medium that moves relative to the platen during printing and the ink that is discharged from the ink head, a track of the ink is changed by the electric charges thus causing printing unevenness occurs.

For example, the ink that is discharged from the ink head has been electrically charged and electric charges have been generated in the ink. Also, the medium is electrically charged by rubbing with the platen when being conveyed, and therefore, electric charges are generated in the medium. However, for example, when the platen and the medium contact each other, electric charges of an opposite polarity to that of electric charges of the medium concentrate on a surface of the platen made of metal and a state in which the electric charges of the electrically charged medium and the electric charges of the surface of the platen are apparently coupled (in other words, an electrically neutralized state) is established. Thus, for a portion in which the platen and the medium contact each other, when the ink is discharged to the medium, the track of ink is hardly changed by the electric charges of the medium. However, when the medium floats up from the platen, a floating portion does not contact the platen. Therefore, for example, the electric charges that have been generated in the floating portion of the medium are not pulled by the electric charges of the platen and exist in the medium. Because of this, the electric charges easily exist also in an upper portion of the medium. The electric charges of the medium and the electric charges of the ink react to each other in the floating portion of the medium, and thereby, the track of the ink that has been discharged from the ink head is changed. As a result, printing unevenness occurs. Then, the present inventor discovered that electricity is removed from the medium before the ink is discharged, and thereby, the track of the ink is hardly shifted due to the electric charges of the medium.

A printer according to a preferred embodiment of the present disclosure includes a support, an ink head, a conveyor, a plasma generator, and an insulator. A medium is placed on the support. The ink head includes a plurality of nozzles that discharge an ink to the medium on the support. The conveyor conveys the medium placed on the support in a first direction from one side to the other side. The plasma generator includes an irradiation port that radiates plasma toward the support and is provided over the support so as to be locatable in a position that overlaps the support in plan view. The insulator is provided on an upper surface of the support so as to be opposed to at least the irradiation port and insulates the support and the medium placed on the support from each other. When a range of the medium which has been irradiated with the plasma by the plasma generator is an irradiated range, the ink head is disposed in a position in which the ink is discharged to the irradiated range of the medium placed on the support.

In a printer according to a preferred embodiment of the present disclosure, the ink is discharged to the irradiated range of the medium which has been irradiated with the plasma, and thereby, printing is performed. In a portion of the medium on which printing has not been performed yet, electric charges exist in the medium but electric charges do not exist in the insulator, and therefore, over the insulator, the electric charges of the medium easily exist in an upper portion of the medium. In the above described state, a range of the medium located over the insulator is irradiated with plasma, and thereby, the electric charges in the range of the medium located over the insulator can be easily removed. Therefore, electric charges hardly exist in the irradiated range of the medium. In various preferred embodiments of the present disclosure, the ink is discharged to the irradiated range of the medium in which electric charges hardly exist, and therefore, the track of the ink is hardly shifted due to the electric charges of the medium. Accordingly, the occurrence of printing unevenness due to the electric charges of the medium is able to be reduced or prevented. As a result, reduction of printing quality due to the electric charges of the medium is able to be decreased or prevented.

According to preferred embodiments of the present disclosure, printers that are each able to decrease or prevent a reduction of printing quality are provided.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a font view of a printer according to a preferred embodiment of the present invention.

FIG. 2 is a cross-sectional view of the printer taken along a line II-II of FIG. 1.

FIG. 3 is a schematic view illustrating a configuration of a surface opposed to a medium in a carriage.

FIG. 4 is a side view of a medium and a platen illustrating a state of electric charges of the medium and electric charges of the platen.

FIG. 5 is a side view of the medium and the platen illustrating a state of electric charges of the medium and electric charges of the platen.

FIG. 6 is a plan view of the platen and the carriage.

FIG. 7 is a plan view of the platen and the carriage schematically illustrating an irradiated range and a printing range.

FIG. 8 is a block diagram of the printer.

FIG. 9 is a side view of the medium and the platen illustrating a state of electric charges of the medium and electric charges of the platen.

FIG. 10 is a schematic view of a printer according to another preferred embodiment illustrating a configuration of a surface opposed to a medium in a carriage.

### DETAILED DESCRIPTION OF THE PREFERRED EMBODIMENTS

With reference to the attached drawings, printers according to preferred embodiments of the present disclosure will be described below. Note that, as a matter of course, preferred embodiments described herein are not intended to be particularly limiting of the present invention. Also, elements and portions that have the same function are denoted by the same reference character and redundant description will be omitted or simplified, as appropriate.

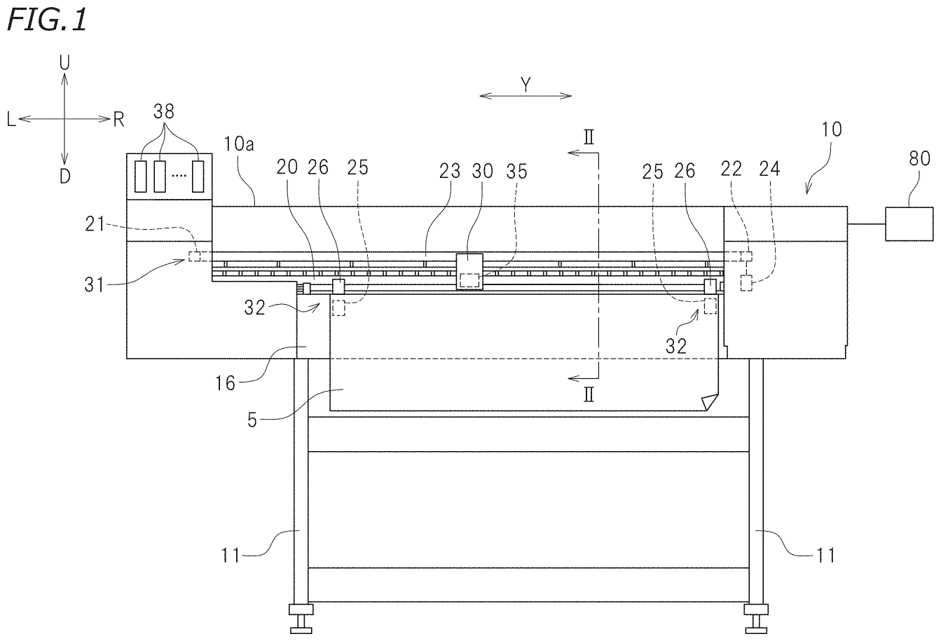

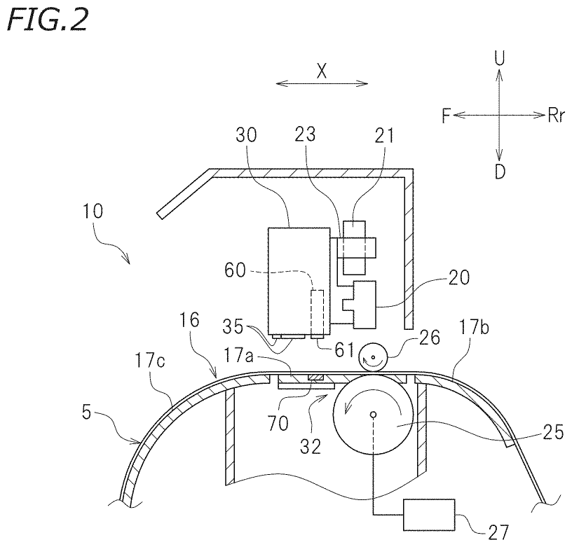

FIG. 1 is a front view of a printer 10 according to a preferred embodiment of the present invention. FIG. 2 is a cross-sectional view of the printer 10 taken along a line II-II of FIG. 1. In the following description, when a user views the printer 10 from front, a direction in which the user goes away from the printer 10 will be referred to as front and a direction in which the user approaches the printer 10 is referred to as rear. The terms left, right, up, and down refer to left, right, up, and down when the printer 10 is viewed from front, respectively. Also, the reference signs F, Rr, L, R, U and D as used in the drawings refer to front, rear, left, right, up and down, respectively. The reference sign Y as used in the drawings denotes a main scanning direction. The main scanning direction Y is a left-right direction. In this preferred embodiment, the main scanning direction Y is an example of a “second direction”. Also, the reference sign X as used in the drawings denotes a sub scanning direction. The sub scanning direction X is a direction from a rear side to a front side and is a front-rear direction. The sub scanning direction X is perpendicular to the main scanning direction Y in plan view. In this preferred embodiment, the sub scanning direction X is an example of a “first direction”. The rear side and the front side are examples of “one side” and “the other side”. However, the above described directions are used merely for the sake of convenience of description, are not intended to limit how the printer 10 is installed in any way, and are not intended to limit the present invention in any way.

As illustrated in FIG. 1, the printer 10 is a device that preforms printing on a medium 5 by discharging an ink to the medium 5. In this case, the printer 10 is a so-called ink jet printer. For example, the printer 10 is a so-called large printer which is long in the main scanning direction Y, as compared to a printer for home use. For example, the printer 10 is a printer for business use. However, the printer 10 may be a printer for home use. The printer 10 sequentially moves the medium 5 to the front side and discharges inks from an ink head 35 (see FIG. 1) that moves in the main scanning direction Y, which will be described later. Thus, an image is printed on the medium 5.

The medium 5 is an object on which an image is printed. Note that there is no particular limitation on a type of the medium 5. The medium 5 may be a paper product, such as, for example, regular paper, inkjet printing paper, or the like. The medium 5 may be rolled paper. Also, the medium 5 may be a transparent sheet made of resin, such as polyvinyl chloride (PVC), polyester, or the like, or made of glass. The medium 5 may be a sheet made of metal or made of rubber.

The printer 10 includes a printer body 10a and legs 11. The printer body 10a includes a casing that extends in the main scanning direction Y. The legs 11 support the printer body 10a. The legs 11 are provided on a lower surface of the printer body 10a.

The printer 10 includes a platen 16. The platen 16 is an example of a “support”. The medium 5 is placed on the platen 16. When printing on the medium 5 is performed, the platen 16 supports the medium 5. Printing on the medium 5 is performed on the platen 16. In this case, the platen 16 extends in the main scanning direction Y.

In this preferred embodiment, as illustrated in FIG. 2, the platen 16 includes a main platen 17a, an upstream platen 17b, and a downstream platen 17c. Printing of an image is performed on the main platen 17a. The main platen 17a is disposed under the ink head 35. An upper surface of the main platen 17a is a flat surface. The upstream platen 17b is disposed behind the main platen 17a and is located on an upstream side of the main platen 17a. The upstream platen 17b guides the medium 5 to the main platen 17a. The upstream platen 17b preferably has, for example, an arc-shaped cross section. The upstream platen 17b is curved such that, as a distance from the main platen 17a increases, a portion of the upstream platen 17b which is located at the distance is positioned lower. The downstream platen 17c is disposed in front of the main platen 17a and is located in a downstream side of the main platen 17a. For example, the downstream platen 17c guides the medium 5 to a winding device (not illustrated) that winds the medium 5 placed on the platen 16. The downstream platen 17c preferably has an arc-shaped cross section. The downstream platen 17c is curved such that, as a distance from the main platen 17a increases, a portion of the downstream platen 17c which is located at the distance is positioned lower.

Note that there is no particular limitation on a material for the platen 16, that is, a material for the main platen 17a, the upstream platen 17b, and the downstream platen 17c. For example, the main platen 17a, the upstream platen upstream platen 17b, and the downstream platen 17c may be made of a material including metal. For example, an upper surface of each of the main platen 17a, the upstream platen 17b, and the downstream platen 17c may be formed of a metal, and portions other than the upper surface of each of the platens may be made of metal or some other material than metal.

As illustrated in FIG. 1, the printer 10 includes a head mover 31 and a medium conveyor 32. The head mover 31 is a mechanism that moves the ink head 35 in the main scanning direction Y. The head mover 31 is an example of a “mover”. Note that there is no particular limitation on a configuration of the head mover 31. In this preferred embodiment, the head mover 31 includes a guide rail 20, a pulley 21, a pulley 22, an endless belt 23, a first driving motor 24, and a carriage 30. The guide rail 20 guides movement of the carriage 30 and the ink head 35 in the main scanning direction Y. As illustrated in FIG. 2, the guide rail 20 is disposed over the platen 16 so as to overlap the platen 16 (specifically, the main platen 17a) in plan view. As illustrated in FIG. 1, the guide rail 20 extends in the main scanning direction Y. The pulley 21 is provided in a left end portion of the guide rail 20. The pulley 22 is provided in a right end portion of the guide rail 20. The belt 23 is wound around the pulley 21 and the pulley 22. In this preferred embodiment, the first driving motor 24 is coupled to the pulley 22 at a right side. However, the first driving motor 24 may be coupled to the pulley 21 at a left side. In this preferred embodiment, the first driving motor 24 is driven to cause the pulley 22 to rotate, and thereby, the belt 23 runs between the pulley 21 and the pulley 22.

The carriage 30 is attached to the belt 23. As illustrated in FIG. 2, the carriage 30 engages the guide rail 20 and is provided as to be freely slidable on the guide rail 20. A plurality of the ink heads 35 is provided in the carriage 30. In this preferred embodiment, the head mover 31 is configured to move the ink heads 35 provided in the carriage 30 in the main scanning direction Y as the belt 23 runs due to driving of the first driving motor 24 and thus the carriage 30 moves in the main scanning direction Y.

The medium conveyor 32 is a mechanism that moves the medium 5 placed on the platen 16 in the sub scanning direction X. In this preferred embodiment, the medium conveyor 32 is an example of a “conveyor”. Note that there is no particular limitation on a configuration of the medium conveyor 32. In this preferred embodiment, as illustrated in FIG. 2, the medium conveyor 32 includes a grit roller 25, a pinch roller 26, and a second driving motor 27. The grit roller 25 is provided in the main platen 17a of the platen 16. In this case, the grit roller 25 is embedded in the main platen 17a such that at least a portion of the grit roller 25 is upwardly exposed.

The pinch roller 26 pinches the medium 5 with the grit roller 25. The pinch roller 26 presses the medium 5 from above. The pinch roller 26 is disposed over the grit roller 25 so as to overlap the grit roller 25 in plan view. The pinch roller 26 is disposed in a position opposed to the grit roller 25. The pinch roller 26 is disposed over the main platen 17a of the platen 16. In this case, the pinch roller 26 is movable in an up-down direction. Note that there is no particular limitation on a disposition position of each of the grit roller 25 and the pinch roller 26 and the number thereof. In this preferred embodiment, as illustrated in FIG. 1, the grit roller 25 and the pinch roller 26 are disposed at least in a left end portion and a right end portion of the platen 16, respectively.

In this preferred embodiment, as illustrated in FIG. 2, the second driving motor 27 is coupled to the grit roller 25. When the second driving motor 27 is driven and thus the grit roller 25 rotates with the medium 5 pinched between the grit roller 25 and the pinch roller 26, the medium 5 is conveyed in the sub scanning direction X. In this case, the medium conveyor 32 is configured to convey the medium 5 placed on the platen 16 toward the front side from the rear side.

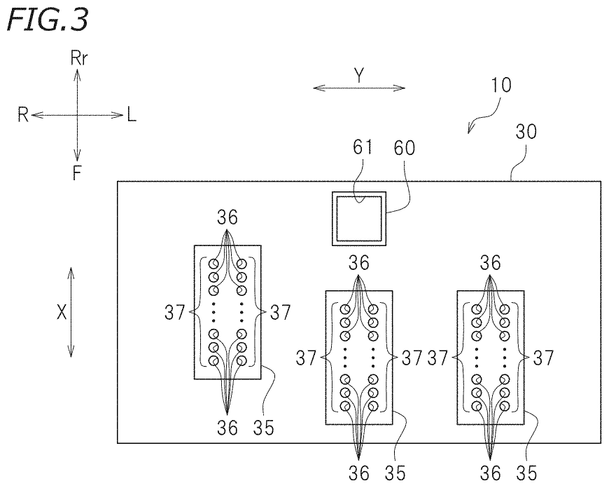

FIG. 3 is a schematic view illustrating a configuration of a surface (a lower surface in this case) opposed to the medium 5 in the carriage 30. As illustrated in FIG. 3, the printer 10 incudes the plurality of ink heads 35. The ink heads 35 discharge inks. The ink heads 35 are provided in the carriage 30 and held on a lower surface of the carriage 30. As illustrated in FIG. 1, the ink heads 35 are disposed above the platen 16. The ink heads 35 are provided so as to be freely slidable on the guide rail 20 via the carriage 30. The ink heads 35 are movable by the head mover 31 in the main scanning direction Y along the guide rail 20. In this preferred embodiment, as illustrated in FIG. 3, the number of the ink heads 35 is three, for example. However, there is no particular limitation on the number of the ink heads 35. Also, there is no particular limitation on disposition positions of the three ink heads 35. In this preferred embodiment, the three ink heads 35 are disposed so as to align in the main scanning direction Y, but one of the three ink heads 35 (one of the ink heads 35 which is located rightmost in this case) is shifted to and located in a position behind the other two ink heads 35. However, positions of front ends of the three ink heads 35 may be the same in the sub scanning direction X and positions of rear ends of the three ink heads 35 may be the same in the sub scanning direction X.

In this preferred embodiment, in each of the ink heads 35, a plurality of nozzles 36 is arranged in two lines in the sub scanning direction X on a lower surface of the ink head 35. In this case, a line in which the nozzles 36 align in the sub scanning direction X will be referred to as a nozzle line 37. In this preferred embodiment, the two nozzle lines 37 are provided for one ink head 35 and, for the entire printer 10, the six nozzle lines 37 are provided. However, there is no particular limitation on the number of the nozzle lines 37. In this case, an ink of a different tone is discharged for each nozzle line 37.

Note that, in this preferred embodiment, each of the plurality of nozzles 36 that define the nozzle lines 37 of the plurality of ink heads 35 is coupled to an ink cartridge 38 (see FIG. 1) via an ink supply path (not illustrated). The ink cartridge 38 is disposed so as to be freely attachable and detachable, for example, in a left end portion of the printer body 10a. Note that there is no particular limitation on a material of inks stored in the ink cartridge 38, that is, inks that are discharged from each of the ink heads 35, and various materials each of which has been conventionally used as a material of an ink of an ink jet printer may be used. For example, the ink may be a solvent-based pigment ink or an aqueous pigment ink, or may be an aqueous dye ink, an ultraviolet curable ink which receives an ultraviolet ray and is cured, or the like.

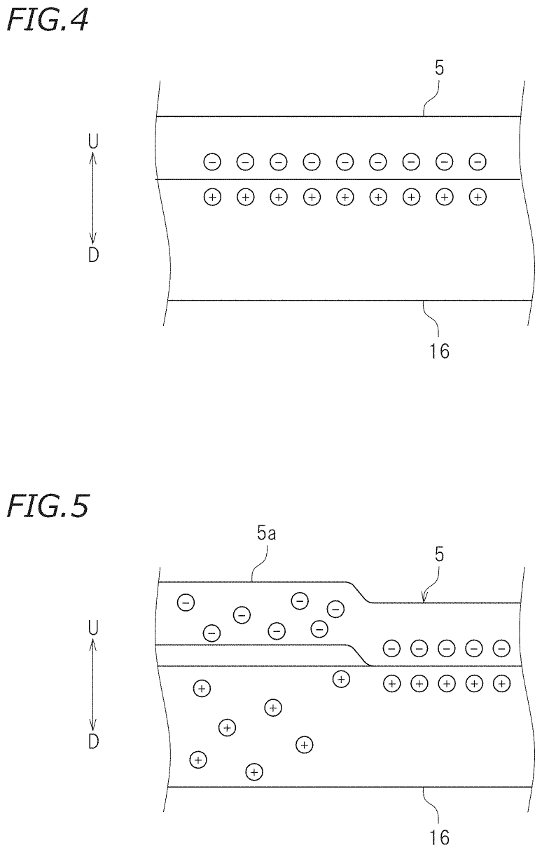

Each of FIG. 4 and FIG. 5 is a side view of the medium 5 and the platen 16 illustrating a state of electric charges of the medium 5 and electric charges of the platen 16. In each of FIG. 4 and FIG. 5, as an example, a state in which negative electric charges are generated in the medium 5 and positive electric charges are generated in the platen 16 is illustrated. Incidentally, when the medium 5 placed on the platen 16 is conveyed toward the front side in the sub scanning direction X, the medium 5 and the platen 16 rub each other, and therefore, there is a probability that the medium 5 is electrically charged. For example, the medium 5 is electrically charged, and thereby, as illustrated in FIG. 4, negative electric charges exist in the medium 5 and positive electric charges exist in the platen 16. In this case, when the medium 5 and the platen 16 completely contact each other, the negative electric charges of the medium 5 and the positive electric charges of the platen 16 pull each other, and therefore, the negative electric charges of the medium 5 concentrate on a lower portion of the medium 5. As a result, a state in which the negative electric charges of the medium 5 and the positive electric charges of the platen 16 are apparently coupled (in other words, an electrically neutralized state) is established. Therefore, when the inks are discharged to a portion in which the medium 5 and the platen 16 completely contact each other, a track of the inks is hardly changed by the electric charges of the medium 5. Therefore, printing unevenness due to the electric charges of the medium 5 hardly occurs.

However, as illustrated in FIG. 5, there is a probability that, during printing, a portion of the medium 5 floats up from the platen 16. For example, the medium 5 is deformed by temperature change depending on a material of the medium 5, and thereby, a portion 5a of the medium 5 floats up from the platen 16. Thus, in the portion 5a (which will be hereinafter referred to as a “floating potion 5a” of the medium 5) that has floated up from the platen 16, the negative electric charges of the medium 5 and the positive electric charges of the platen 16 hardly pull each other, that is, are hardly electrically neutralized. Therefore, there is a probability that, in the floating portion 5a of the medium 5, the negative electric charges do not concentrate in the lower portion of the medium 5 and exit in an upper portion of the medium 5. In this case, the inks that are discharged from the ink head 35 are electrically charged. For example, when negative electric charges are generated in the inks, in the floating portion 5a of the medium 5, the negative electric charges of the medium 5 and the negative electric charges of the inks repel each other, and therefore, the track of the inks is shifted. There is a probability that a hitting position of the inks on the medium 5 is shifted by the shift of the track of the inks in the above described manner. Then, printing unevenness occurs due to the shift of the track of the inks. There is a probability, as a result, that printing quality is reduced in some cases.

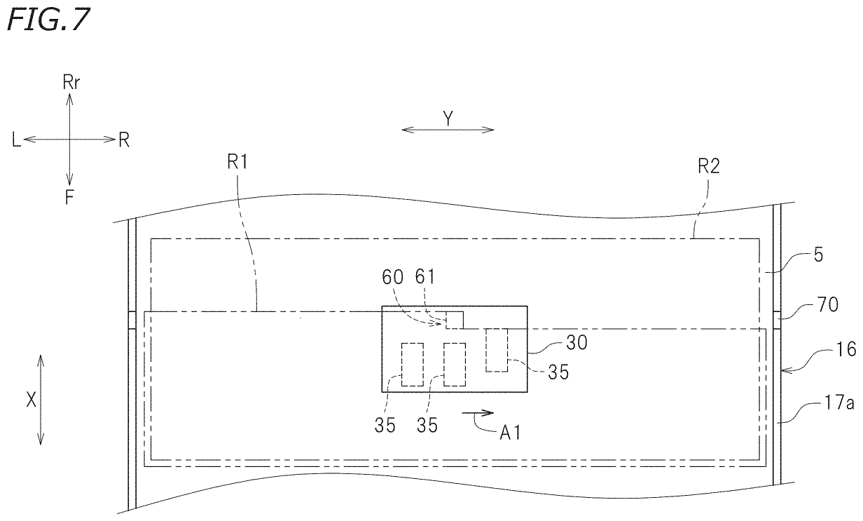

Therefore, in this preferred embodiment, even when the floating portion 5a of the medium 5 is generated, a decrease or prevention of a reduction of printing quality due to the shift of the track of the inks is realized. In this case, a portion of the medium 5 on which printing has not been performed yet is irradiated with plasma. In this case, a range of the medium 5 which has been irradiated with the plasma will be referred to an irradiated range R1 (see FIG. 7). In the printer 10 according to this preferred embodiment, printing is performed by discharging the inks to the irradiated range R1 of the medium 5 from the ink head 35. The ink head 35 is disposed in a position in which the ink head 35 discharges the inks to the irradiated range R1 of the medium 5 placed on the platen 16.

In this preferred embodiment, as illustrated in FIG. 2, the printer 10 includes a plasma generator 60 and an insulation layer 70. The plasma generator 60 irradiates the medium 5 placed on the platen 16 with plasma. The plasma generator 60 is provided over the main platen 17a so as to be located in a position that overlaps the main platen 17a of the platen 16 in plan view. In this preferred embodiment, the plasma generator 60 is provided in the carriage 30. Therefore, the plasma generator 60 is movable with the carriage 30 and the plurality of ink heads 35 in the main scanning direction Y.

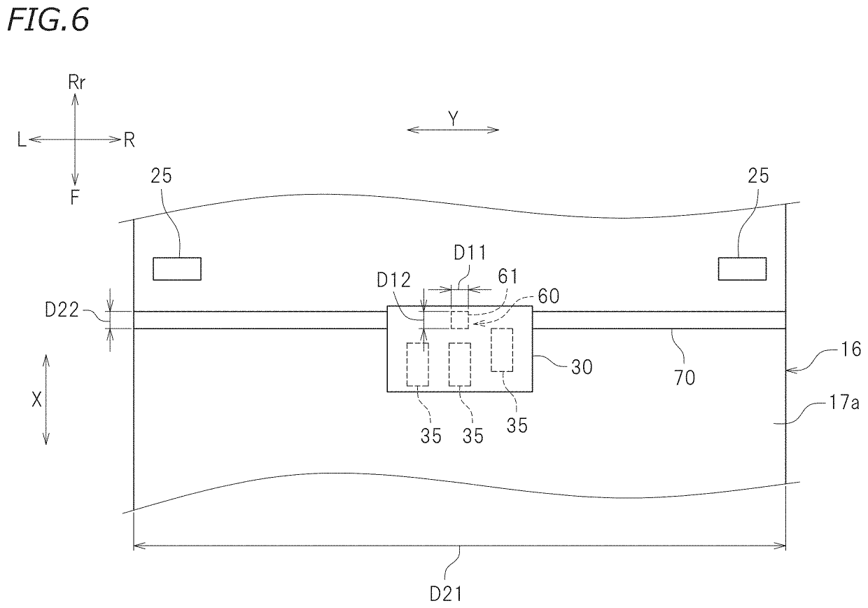

As illustrated in FIG. 3, the plasma generator 60 includes an irradiation port 61. Although not illustrated in the drawings, a generation source that generates plasma is disposed in the plasma generator 60. Plasma that has been emitted from the generation source passes through the irradiation port 61, and thereby, the plasma is downwardly radiated from the irradiation port 61. In other words, the plasma is radiated toward the main platen 17a from the irradiation port 61. In this preferred embodiment, the irradiation port 61 is located on a lower surface of the plasma generator 60 and opens downwardly. Note that there is no particular limitation on a shape and a size of the irradiation port 61. In this preferred embodiment, the irradiation port 61 has a rectangular or substantially rectangular shape, but may have a circular or substantially circular shape, for example. FIG. 6 is a plan view of the platen 16 and the carriage 30. There is no particular limitation on a relationship between a length D11 of the irradiation port 61 in the main scanning direction Y and a length D12 of the irradiation port 61 in the sub scanning direction X. For example, the length D11 of the irradiation port 61 may be the same as the length D12 of the irradiation port 61. The length D11 of the irradiation port 61 may be shorter than the length D12 and may be longer than the length D12.

As illustrated in FIG. 3, the plasma generator 60 is disposed such that the irradiation port 61 is located behind all of the plurality of nozzles 36 of the ink heads 35. In this case, the plasma generator 60 is disposed such that the irradiation port 61 is located behind each of the three ink heads 35. Also, the plasma generator 60 is disposed in a central portion in the main scanning direction Y in the carriage 30. However, the plasma generator 60 may be disposed in a right side portion of the carriage 30 and may be disposed in a left side portion of the carriage 30. In this preferred embodiment, as illustrated in FIG. 2, the irradiation port 61 is disposed in front of the grit roller 25 and the pinch roller 26 in plan view. The irradiation port 61 is disposed between the ink heads 35 and the grit roller 25 and between the ink heads 35 and the pinch roller 26 in plan view. In this case, the grit roller 25 and the pinch roller 26 when being used as comparison targets to which positions of the plasma generator 60 and the insulation layer 70 are compared mean a portion of the grit roller 25 which contacts the medium 5 and a portion of the pinch roller 26 which contacts the medium 5, respectively.

In this preferred embodiment, as illustrated in FIG. 3, the number of the plasma generators 60 is one, for example. However, there is no particular limitation on the number of the plasma generators 60. For example, a plurality of plasma generators 60 (for example, two or more plasma generators 60) may be provided in the carriage 30.

FIG. 7 is a plan view of the platen 16 and the carriage 30 schematically illustrating the irradiated range R1 and a printing range R2. In FIG. 7, an arrow A1 indicates a direction in which the carriage 30 is conveyed. In FIG. 7, the carriage 30 is conveyed from left to right. In this preferred embodiment, as illustrated in FIG. 7, in the medium 5, the printing range R2 that is a range in which printing is performed has been set in advance. The printing range R2 is a range that overlaps the nozzle lines 37 of the plurality of ink heads 35 in plan view while the plurality of ink heads 35 moves in the main scanning direction Y. In this case, while the plasma generator 60 moves with the carriage 30 in the main scanning direction Y, the irradiation port 61 of the plasma generator 60 overlaps the printing range R2 in plan view. That is, the printing range R2 of the medium 5 is irradiated with plasma that has passed through the irradiation port 61.

As illustrated in FIG. 2, the insulation layer 70 insulates the platen 16 and the medium 5 (specifically, the medium 5 placed on the platen 16) from each other. The insulation layer 70 is an example of an “insulator”. The insulation layer 70 is provided on the upper surface of the main platen 17a of the platen 16. An upper surface of the insulation layer 70 is flush with the upper surface of the main platen 17a. In other words, the upper surface of the insulation layer 70 is flush with the upper surface of each of portions of the main platen 17a disposed in front of and behind the insulation layer 70 and there is no step therebetween. The insulation layer 70 is opposed to at least the irradiation port 61 of the plasma generator 60 in side view. In other words, the insulation layer 70 is disposed at least directly under the irradiation port 61 in side view. In this case, the insulation layer 70 is not opposed to the ink heads 35 in side view. However, the insulation layer 70 may be opposed to the ink heads 35 in side view. In other words, the insulation layer 70 may be disposed directly under the ink heads 35 in side view. Also, the insulation layer 70 is disposed in front of the grit roller 25. The insulation layer 70 is disposed in front of the pinch roller 26 in side view.

In this preferred embodiment, as illustrated in FIG. 6, the insulation layer 70 extends in the main scanning direction Y. In this case, a length D21 of the insulation layer 70 in the main scanning direction Y is longer than a length D22 of the insulation layer 70 in the sub scanning direction X. The length D21 of the insulation layer 70 in the main scanning direction Y is longer than the length D11 of the irradiation port 61 of the plasma generator 60 in the main scanning direction Y. Note that the length D22 of the insulation layer 70 in the sub scanning direction X may be the same as the length D12 of the irradiation port 61 in the sub scanning direction X and may be longer than the length D12. The length D21 of the insulation layer 70 in the main scanning direction Y is the same as a length of the printing range R2 of the medium 5 in the main scanning direction Y or is longer than the length of the printing range R2 in the main scanning direction Y.

In this preferred embodiment, the insulation layer 70 is made of an insulating material. In this case, the insulating material is a material that insulates the platen 16 and the medium 5 from each other and a material that does not conduct electricity. The insulation layer 70 is made of, for example, rubber or resin.

In this preferred embodiment, as illustrated in FIG. 1, the printer 10 includes a controller 80. The controller 80 is configured or programmed to control printing on the medium 5 and also control a timing at which plasma that is emitted from the plasma generator 60 is radiated or the like. There is no particular limitation on a configuration of the controller 80. The controller 80 may include, for example, a microcomputer. The controller 80 includes a central control unit (CPU), a ROM that stores a program or the like that is executed by the CPU, a RAM, or the like. In this case, the controller 80 uses the program stored in the microcomputer to perform control related to printing and irradiation of plasma. In this preferred embodiment, the controller 80 is provided in the printer body 10a. However, the controller 80 may not be provided in the printer body 10a and may be, for example, a computer installed outside the printer body 10a. In this case, the controller 80 is communicably coupled to the printer body 10a via a wired or wireless connection.

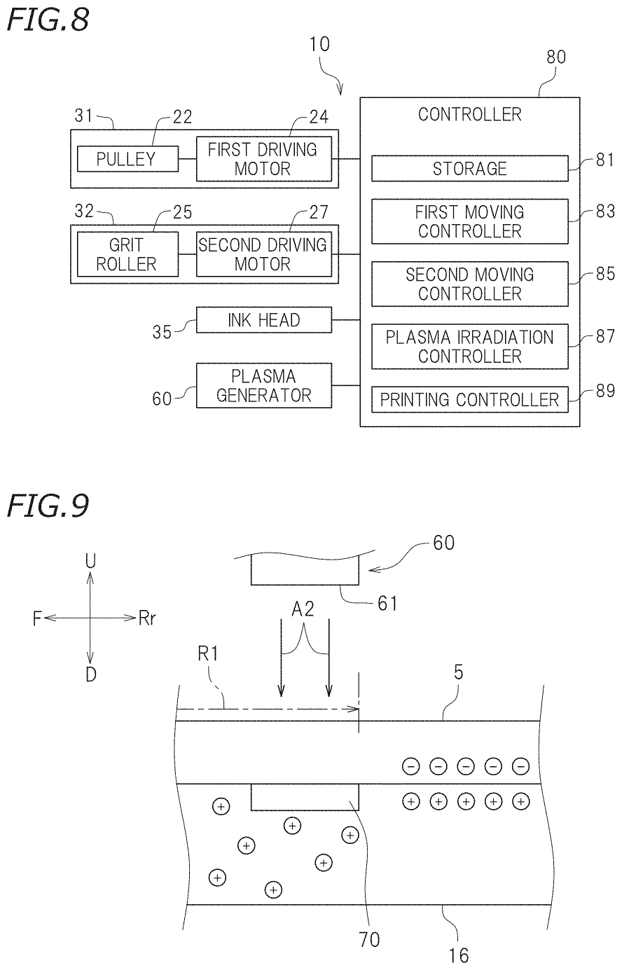

FIG. 8 is a block diagram of the printer 10. In this preferred embodiment, as illustrated in FIG. 8, the controller 80 is communicably coupled to the first driving motor 24 of the head mover 31, the second driving motor 27 of the medium conveyor 32, the ink head 35, and the plasma generator 60. The controller 80 controls the first driving motor 24, the second driving motor 27, the ink head 35, and the plasma generator 60.

In this preferred embodiment, the controller 80 includes a storage 81, a first moving controller 83, a second moving controller 85, a plasma irradiation controller 87, and a printing controller 89. Note that each of the elements of the controller 80 may be configured by a software and may be configured by a hardware. For example, each of the above described elements may be operated by a processor and may be incorporated in a circuit.

The first moving controller 83 is configured or programmed to control the head mover 31 to move the carriage 30 in the main scanning direction Y. Specifically, the first moving controller 83 controls driving of the first driving motor 24 of the head mover 31 to control rotation of the pulley 22 and running of the belt 23 (see FIG. 1). Thus, movement of the ink head 35 and the plasma generator 60 in the main scanning direction Y is controlled.

The second moving controller 85 is configured or programmed to control, after the carriage 30 reciprocates once in the main scanning direction Y, the medium conveyor 32 to convey the medium 5 placed on the platen 16 to the front side. In this case, the second moving controller 85 controls driving of the second driving motor 27 of the medium conveyor 32 to control rotation of the grit roller 25, thereby controlling movement of the medium 5 placed on the platen 16 to the front side.

The plasma irradiation controller 87 is configured or programmed to perform control such that plasma is radiated toward the medium 5 from the irradiation port 61 of the plasma generator 60 in a state in which the carriage 30 is moved in the main scanning direction Y by the first moving controller 83. In this case, the plasma irradiation controller 87 performs control such that, when the irradiation port 61 passes directly over the printing range R2 of the medium 5, plasma is radiated downwardly from the irradiation port 61. Thus, the printing range R2 of the medium 5 is irradiated with plasma. Note that, as illustrated in FIG. 7, a range in the printing range R2 which has been irradiated with the plasma is the irradiated range R1.

The printing controller 89 is configured or programmed such that, in a state in which the carriage 30 is moved in the main scanning direction Y by the first moving controller 83, the inks are downwardly discharged from the nozzles 36 of the ink heads 35. In this case, the printing controller 89 performs control such that, when the ink head 35 passes directly over the irradiated range R1 of the medium 5, the inks are discharged to the irradiated range R1 from the nozzles 36 of the ink head 35, based on a printed image stored in the storage 81.

The configuration of the printer 10 according to this preferred embodiment has been described above. Next, procedures of removing the electric charges of the medium 5 before printing will be described.

In this preferred embodiment, as described above, as illustrated in FIG. 4, when the medium 5 placed on the platen 16 is conveyed toward the front side, the medium 5 and the platen 16 rub each other, and therefore the medium 5 is electrically charged. FIG. 9 is a side view of the medium 5 and the platen 16 illustrating a state of electric charges of the medium 5 and electric charges of the platen 16. In FIG. 9, an arrow A2 indicates an irradiation direction of plasma. As illustrated in FIG. 9, before the plasma is radiated, that is, in side view, in a portion of the medium 5 which is located behind of the irradiation port 61, a state in which negative electric charges of the medium 5 and positive electric charges of the platen 16 pull each other is established and an electrically neutralized state is established. Then, when the medium 5 is disposed on the insulation layer 70, plasma is radiated toward the medium 5 from the irradiation port 61 of the plasma generator 60. At this time, the insulation layer 70 is disposed under a range of the medium 5 which is irradiated with plasma. Therefore, the positive electric charges of the platen 16 do not exist directly under the irradiated range R1. Therefore, the negative electric charges in the irradiated range R1 of the medium 5 easily exist also in the upper portion of the medium 5, and therefore, are easily removed by irradiation with the plasma.

Next, the irradiated range R1 of the medium 5 in a state in which the negative electric charges have been removed is conveyed to the front side and the inks are discharged to the irradiated range R1. At this time, electric charges exist in inks that have been discharged from the ink heads 35, but electric charges do not exist in the irradiated range R1 of the medium 5. Therefore, the track of the inks is hardly changed due to the electric charges of the medium 5. Accordingly, the occurrence of printing unevenness due to the electric charges of the medium 5 is able to be decreased or prevented. As a result, reduction of the printing quality due to the electric charges of the medium 5 is able to be decreased or prevented.

In this preferred embodiment, as illustrated in FIG. 3, the plasma generator 60 is disposed such that a front end of the irradiation port 61 is located behind one of the plurality of nozzles 36 of the plurality of ink heads 35, which is located in a rearmost position, in side view. Thus, the inks from the ink heads 35 are able to be discharged to the irradiated range R1 which has been reliably irradiated with plasma emitted from the irradiation port 61.

In this preferred embodiment, the plasma generator 60 is provided in the carriage 30 in which the ink heads 35 are provided. Thus, the plasma generator 60 can be moved in the main scanning direction Y using the mechanism (the head mover 31 in this case) that moves the ink heads 35 in the main scanning direction Y. Accordingly, an exclusive mechanism used to move the plasma generator 60 in the main scanning direction Y is not provided, and therefore, the number of components is able to be reduced.

In this preferred embodiment, as illustrated in FIG. 6, the length D11 of the irradiation port 61 of the plasma generator 60 in the main scanning direction Y is shorter than the length D21 of the insulation layer 70 in the main scanning direction Y. In this case, the plasma generator 60 is movable in the main scanning direction Y. Therefore, even in a case in which the length D11 of the irradiation port 61 in the main scanning direction Y is shorter than the length D21 of the insulation layer 70 in the main scanning direction Y, the entire printing range R2 of the medium 5 is able to be irradiated with plasma by moving the plasma generator 60 in the main scanning direction Y. Therefore, a size of the plasma generator 60 is not increased.

In this preferred embodiment, the insulation layer 70 is a layer made of an insulating material that insulates the platen 16 and the medium 5 from each other. Thus, the insulation layer is interposed between the medium 5 and the platen 16, and thereby, the medium 5 and the platen 16 are able to be easily insulated from each other.

In this preferred embodiment, as illustrated in FIG. 2, the upper surface of the insulation layer 70 and the upper surface of the platen 16 (specifically, the main platen 17a) are flush with each other. Thus, the medium 5 placed on the platen 16 can be smoothly conveyed in the sub scanning direction X.

In this preferred embodiment, as illustrated in FIG. 6, the insulation layer 70 is a layer that extends in the main scanning direction Y. In this case, the length D21 of the insulation layer 70 in the main scanning direction Y is longer than the length D22 of the insulation layer 70 in the sub scanning direction X. The insulation layer 70 may be disposed at least in a position opposed to the irradiation port 61 in side view and may extend in the same direction as a direction in which the plasma generator 60 is moved. Therefore, even in a case in which the insulation layer 70 does not extend in the sub scanning direction X, the electric charges of the medium 5 can be sufficiently removed.

In this preferred embodiment, the length D22 of the insulation layer 70 in the sub scanning direction X is equal to or longer than the length D12 of the irradiation port 61 in the sub scanning direction X. Thus, a portion of the medium 5 which is located on the insulation layer 70 is able to be easily irradiated with plasma from the irradiation port 61. Therefore, the electric charges of the medium 5 are easily removed.

In this preferred embodiment, as illustrated in FIG. 2, the plasma generator 60 is disposed such that the irradiation port 61 is located in front of the grit roller 25 in side view. Also, the plasma generator 60 is disposed such that the irradiation port 61 is located in front of the pinch roller 26 in side view. The medium 5 placed on the platen 16 is conveyed to the front side in a state being pinched by the grit roller 25 and the pinch roller 26. At this time, the medium 5 contacts the grit roller 25 and the pinch roller 26. Therefore, more electric charges are generated in the medium 5 in a portion of the medium 5 after being pinched by the grit roller 25 and the pinch roller 26. However, in this preferred embodiment, the plasma generator 60 is disposed in front of the grit roller 25 and the pinch roller 26, and therefore, the portion of the medium 5 after being pinched by the grit roller 25 and the pinch roller 26 is irradiated with plasma. Accordingly, the electric charges of the medium 5 which have been generated by pinching the medium 5 by the grit roller 25 and the pinch roller 26 are able to be efficiently removed.

The printer 10 according to this preferred embodiment has been described above. Next, a printer according to another preferred embodiment will be described. In the following description, a similar component to each component that has been already described is denoted by the same reference symbol of the component and the description thereof will be omitted.

In the above described preferred embodiment, the plasma generator 60 is disposed such that the irradiation port 61 is located behind the plurality of nozzles 36 of each ink head 35 in side view. However, the disposition position of the plasma generator 60 is not limited to the above described position.

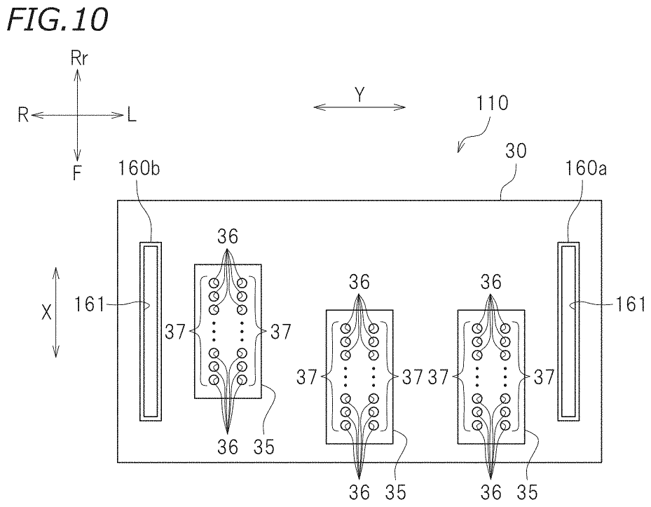

FIG. 10 is a schematic view of a printer 110 according to another preferred embodiment illustrating a configuration of a surface (a lower surface in this case) opposed to a medium 5 in a carriage 30. As illustrated in FIG. 10, the printer 110 preferably includes two plasma generators 160a and 160b, for example. The left plasma generator 160a is disposed at left of three ink heads 35. The left plasma generator 160a is disposed at left of one of the three ink heads 35 which is located leftmost. The right plasma generator 160b is disposed at right of the three ink heads 35. The right plasma generator 160b is disposed at right of one of the three ink heads 35 which is located rightmost. In this case, the three ink heads 35 are disposed between the two plasma generators 160a and 160b.

Each of the plasma generators 160a and 160b includes an irradiation port 161 on a lower surface of the each of the plasma generators 160a and 160b. In this case, a position of a front end of the irradiation port 161 in the sub scanning direction X is the same as a position of one of nozzles 36 of the three ink heads 35 located frontmost in the sub scanning direction X. A position of a rear end of the irradiation port 161 in the sub scanning direction X is the same as a position of one of nozzles 36 of the three ink heads 35 located rearmost in the sub scanning direction X.

In this preferred embodiment, in a case in which a configuration in which, when the carriage 30 is moved from right to left in the main scanning direction Y, the inks are discharged from the ink heads 35 is used, a plasma irradiation controller 87 (see FIG. 8) controls the left plasma generator 160a such that plasma is radiated from the irradiation port 161 of the left plasma generator 160a. On the other hand, in a case in which a configuration in which, when the carriage 30 is moved from left to right in the main scanning direction Y, the inks are discharged from the ink heads 35 is used, the plasma irradiation controller 87 controls the right plasma generator 160b such that plasma is radiated from the irradiation port 161 of the right plasma generator 160b.

In this preferred embodiment, the inks from the ink heads 35 are discharged to an irradiated range R1 of the medium 5 that has been irradiated with plasma. Therefore, track of the inks is hardly changed due to electric charges of the medium 5. Accordingly, the occurrence of printing unevenness due to the electric charges of the medium 5 is able to be decreased or prevented. As a result, reduction of the printing quality due to the electric charges of the medium 5 is able to be decreased or prevented.

In each of the above described preferred embodiments, the insulation layer 70 is an insulator. However, the insulator of the present disclosure is not limited to a layer formed of an insulating material. For example, the insulator may be a groove located in an upper surface of the platen 16. This groove extends, for example, in the main scanning direction Y. There is no particular limitation on a depth of the groove, but the depth of the groove is, for example, about 20 mm to about 30 mm. In this case, the medium 5 and the platen 16 are able to be isolated from each other by air that enters the groove.

In each of the above described preferred embodiments, the plasma generator 60 is provided in the carriage 30, but may not be provided in the carriage 30 and may be configured so as not to move in the main scanning direction Y. For example, the plasma generator 60 may be attached to the printer body 10a. In this case, a plurality of the plasma generators 60 may be opposed to the insulation layer 70 and align in the main scanning direction Y.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer comprising:
a support on which a medium is placed;
an ink head including a plurality of nozzles that discharge an ink to the medium on the support;
a conveyor that conveys the medium placed on the support in a first direction from one side to the other side;
a plasma generator including an irradiation port that radiates plasma toward the support and provided over the support so as to be locatable in a position that overlaps the support in plan view; and
an insulator that is provided on an upper surface of the support so as to be opposed to at least the irradiation port and insulates the support and the medium placed on the support from each other; wherein
when a range of the medium which has been irradiated with the plasma by the plasma generator is an irradiated range, the ink head is disposed in a position in which the ink is discharged to the irradiated range of the medium placed on the support.

2. The printer according to claim 1, wherein the plasma generator is disposed such that, when viewed from a second direction that intersects the first direction in plan view, an end of the irradiation port on the other side is located closer to the one side than one of the plurality of nozzles of the ink head located closest to the one side.

3. The printer according to claim 1, further comprising:
a carriage provided in the ink head; wherein
the plasma generator is provided in the carriage.

4. The printer according to claim 3, further comprising:
a mover that moves the carriage in a second direction that intersects the first direction in plan view; wherein
a length of the irradiation port of the plasma generator in the second direction is shorter than a length of the insulator in the second direction.

5. The printer according to claim 1, wherein the insulator is a layer made of an insulating material that insulates the support and the medium placed on the support from each other.

6. The printer according to claim 5, wherein an upper surface of the insulator and an upper surface of the support are flush with each other.

7. The printer according to claim 1, wherein the insulator extends in a second direction that intersects the first direction in plan view.

8. The printer according to claim 1, wherein
the conveyor includes a grit roller disposed closer to the one side than the insulator when viewed from a second direction that intersects the first direction in plan view and provided in the support; and
the plasma generator is disposed such that the irradiation port is located closer to the other side than the grit roller.

9. The printer according to claim 8, wherein
the conveyor includes a pinch roller that is disposed over the grit roller so as to overlap the grit roller in plan view and pinches the medium placed on the support with the grit roller; and
the plasma generator is disposed such that the irradiation port is located closer to the other side of the pinch roller.

10. The printer according to claim 1, wherein a length of the insulator in the first direction is equal to or longer than a length of the irradiation port of the plasma generator in the first direction.

11. The printer according to claim 1, wherein the support is made of a material including a metal.
